(19) United States
(12) Patent Application Publication
(10) Pub. No.: US 2025/0019002 A1
(43) Pub. Date: Jan. 16, 2025

(54) ELECTRIC STEERING DEVICE FOR CONTROLLING A VEHICLE AND VEHICLE, IN PARTICULAR MOTOR VEHICLE

(71) Applicant: Schaeffler Technologies AG & Co. KG, Herzogenaurach (DE)

(72) Inventor: Johannes Reinschke, Nürnberg (DE)

(73) Assignee: Schaeffler Technologies AG & Co. KG, Herzogenaurach (DE)

(21) Appl. No.: 18/712,762

(22) PCT Filed: Oct. 27, 2022
(86) PCT No.: PCT/DE2022/100799

§ 371 Date: May 23, 2024

(30) Foreign Application Priority Data
Nov. 29, 2021 (DE) 10 2021 131 224.8

(51) Int. Cl. B62D 6/00; B62D 5/00

(52) U.S. Cl. CPC B62D 6/008; B62D 5/006; B62D 6/002

(57) ABSTRACT

The disclosure relates to an electric steering device for controlling a vehicle, that includes a rotation angle encoder, a steering wheel, an electric motor, connected with mechanical action to the steering wheel, a steering actuator arranged at a road end, and a control unit. A steering movement of the steering actuator is controlled via the control unit when a rotational input is made on the steering wheel. Haptic feedback relating to a driving state is introduced into the steering wheel via the electric motor on the basis of a transmission function stored in the control unit and on aggregated information about a road-end steering state on the steering actuator. The aggregated information contains first comparison information, determined in a prediction device, for the road-end steering state depending on driving state information about the vehicle. The disclosure also relates to a vehicle, in particular a motor vehicle.

### CROSS-REFERENCE TO RELATED APPLICATIONS

This application is the U.S. National Phase of PCT Application No. PCT/DE2022/100799 filed on Oct. 27, 2022, which claims priority to DE 10 2021 131 224.8 filed on Nov. 29, 2021, the entire disclosures of which are incorporated by reference herein.

### TECHNICAL FIELD

The disclosure relates to an electric steering device for controlling a vehicle.

### BACKGROUND

Electric steering devices are used-among other applications, in motor vehicles—to receive a directional request from a driver and convert it into corresponding movements of one or more road-end wheels. In particular, fully electric steering devices, so-called “steer-by-wire” steering devices, are known for this purpose. These steer-by-wire steering devices have the advantage that the control unit can be positioned relatively freely within the vehicle independently of mechanical connecting components, which also leads, for example, to improved outcomes in the event of an accident due to the elimination of a mechanical steering column.

In this context, however, it is a hindrance that signals collected directly at a steering actuator require a relatively long processing time in a control unit with regard to feedback on the road condition, so that corresponding feedback on the road condition can only be forwarded to an operator with a delay. However, it is also known in this regard that feedback must be provided below a certain time threshold in order for the driver to perceive the feedback as “real”. Otherwise, unrealistic or dangerous feedback behavior will occur, which in the worst case can lead to unsafe driving states. In addition, the feedback must be subject to certain criteria regarding the integrity of the signals.

### SUMMARY

The object of the disclosure is to improve the prior art.

The object is achieved by an electric steering device for controlling a vehicle according to that which is described herein.

By means of first comparison information for the road-end steering state determined in a prediction device, the aggregated information can be leveraged in order to use predicted comparison information for feedback on the road-end steering state and thus the latency time of the corresponding signal feedback can be shortened significantly, so that the operator is provided with the aforementioned “real” steering feel with real feedback on the road condition.

The following terms should be explained at this point:

A “vehicle” is, for example, a motor vehicle, a car, a truck or another vehicle which is to be controlled by means of the electric steering device. In this context, “control” is defined as the process in which, for example, an operator and/or a driver or an autonomous device acts on the vehicle such that its driving state, in particular its direction of travel, and/or, for example, a steering angle of the electric steering device is actively and deliberately changed.

A “rotation angle encoder”, which can, for example, be part of a rotation mount of an electric steering device, is, for example, an electric, electromechanical, magnetic or optical sensor, which acquires a rotation of a steering wheel about a steering axis that is essentially fixed in space and converts it into a corresponding signal. Such a rotation angle encoder indicates, for example, a rotational position of a steering wheel in relation to a straight-ahead position of the steering wheel or another absolute angle of the steering wheel about the steering axis.

A “steering wheel” is any element that is capable of receiving an input from an operator. Such a “steering wheel” can be designed to be essentially round in the form of a steering rim and has a connection between the steering rim and the rotation mount. The steering wheel can also be designed as a yoke, control stick or joystick. A “rotational input” is to be understood both as a physical rotation of the steering wheel or analog input on a joystick, for example, and as a static holding of the steering wheel or joystick, for example. In this regard, the rotational input is the respective physical representation of the directional request of an operator, which can in particular also include maintaining the direction of travel and thus a static holding of the steering wheel in a certain rotational position.

An “electric motor” is an electromotive unit that performs a mechanical action such as a linear or polar movement or exerts a force or torque based on an electric input signal. In this context, the electric steering device acts on a “steering actuator”, for example an electric motor or a hydraulic unit, which is controlled by the electric steering device and has an active influence on the control of the vehicle, for example by moving tie rods of a steering control or otherwise mechanically triggering the steering process.

A “control unit” is any device that is suitable for outputting control commands and, depending on the embodiment, also for receiving and processing information from other systems, assemblies or sensors, for example, and for influencing the control commands depending on this information, such as a signal from a sensor. From a control theory perspective, this can be an open-loop control system, i.e., a signal output without feedback of the consequences triggered by it, as well as a closed-loop control system, i.e., a signal output depending on information and the feedback of one of the consequences triggered by it (closed control loop). From a physical perspective, this control unit can be arranged in any way, for example as part of a driver-end arrangement, as part of a road-end arrangement or even in a separate control unit, for example as part of a body control system.

A “transmission function” is any mathematical function that is suitable for unambiguously describing the transmission of information and thus allowing a clear assignment of certain input variables to certain output variables by means of this transmission function. The specific assignment of the respective input variables to the respective output variables for a specific operating range is generally referred to as the “transmission behavior”.

In this context, the term “aggregated information about a road-end steering state” refers to an aggregated, for example accumulated, information situation, in particular in the form of an electronic signal, about a road-end steering state, so that the electric steering device contains a representation of a feedback of the road-end conditions of the electric steering device that is as close to reality as possible. In this context, the term “road-end” describes, for example, a steering state of the steered wheels, a guiding arrangement of these wheels as well as other influences, for example due to road conditions or other components of the vehicle.

The term “haptic feedback” refers to the torque applied to the steering wheel by the electric motor, for example, or a force applied with respect to the driver, which provides feedback that can be physically felt, i.e., experienced haptically.

A “prediction device” is a device that is suitable for outputting control commands and, depending on the embodiment, also for receiving and processing information from other systems, assemblies or sensors, for example, and for influencing the control commands depending on this information, such as a signal from a sensor. In this regard, a prediction device has means for making a prediction, for example using mathematical methods, and thus is capable of, on the basis of previously recorded information, making a statement about a future value of a signal dependent on this information and outputting it. In this context, an output signal of such a prediction device is a referred to as “comparison information”, which is formed as predicted information about the road-end steering state depending on driving state information of the vehicle. Such “driving state information” is, for example, the information that represents the road-end steering state in a data signal, for example.

By means of second comparison information, third comparison information and/or further comparison information determined in the prediction device, for example, first comparison information relating to the driving behavior of a first driver, second comparison information relating to the driving behavior of a second driver and, accordingly, further comparison information relating to different driving behaviors of other drivers can be used to provide the most realistic possible haptic feedback on the road-end steering state on the steering wheel for the respective driver, adapted to, for example, a sporty driving style or a particularly defensive driving style. This can be used to switch between different driving modes, for example.

By means of an artificial neural network, a road-end steering state can be predicted particularly reliably and precisely from recorded information, for example by means of corresponding learning cycles of the artificial neural network. Limiting the artificial neural network, in particular by means of limit values, ensures that values predicted by the artificial neural network that are not permissible are actively disregarded and not taken into account, so that no dangerous driving states can arise, for example.

In this context, an “artificial neural network” is a network of so-called artificial neurons, wherein this refers to a network of individual information carriers, namely the neurons, in a technical system. Such artificial neural networks are used to physically map artificial intelligence and thus create an adaptive technical structure that can be trained and thus made more precise using, for example, training tasks or experience from previous decisions.

In this context, it should be mentioned that limit values for limiting a permissible value range are, for example, limit values that define an impermissible steering torque for a driver, or also an impermissible steering torque jump from a very high steering torque to a very low steering torque or from a very low steering torque to a very high steering torque within a certain period of time.

If the prediction device, in particular the artificial neural network, is trained and/or repeatedly trained using the driving state information of the vehicle, an initial training can be carried out using factory-provided comparison information or a factory-provided set of parameters, for example. Similarly, a new training can be carried out once for certain events or repeatedly after a period of time has elapsed, for example. For example, additionally every time before the vehicle is driven, for example each time the ignition of a motor vehicle is switched on, training can be carried out and/or comparison information can be selected depending on the measured parameters, such as an ambient temperature, information from a rain sensor, information from a body electronics system or similar.

Such a “training” describes the process in which, in particular, an artificial neural network is conditioned with tasks in such a way that a learning effect occurs, for example a prediction is made more precise based on the previous experience acquired by the artificial neural network. This can be done at the factory, for example, or during driving operation, even repeatedly.

Aggregated information comprising reference information can, for example, represent a fall-back level that can be used as an alternative to the aggregated information. Likewise, the reference information can also be used as a reference for the aggregated information, for example regarding permissible values.

In this regard, such reference information is in particular a result of an analytical basic function of a vehicle model of the vehicle depending on the driving state information. An “analytical basic function” of a vehicle model can, for example, be a mathematical representation of the driving physics of a vehicle model. These analytical basic functions are evaluated and the result is passed to a single set or multiple sets of driving state information, so that an analytical result about a probable driving state and/or probable road-end state is output. Dangerous driving states can be avoided in this manner.

By means of an adjustment factor and/or filter associated with the respective comparison information, the adjustment factor can be selected and set using external parameters, for example, so that the respective comparison information is used to an increased or reduced extent. A filter can also be used which, for example, disregards certain information areas of the respective comparison information. In this regard, a respective comparison information is in particular a respective comparison information adjusted by means of the adjustment factor and/or respective comparison information filtered by means of the filter.

In order to attain a high level of safety, the electric steering device is configured such that when it is detected that a critical difference between the reference information and the comparison information is exceeded and/or in the event that a critical driving state information is detected by means of a comparison with a non-critical driving state information, the aggregated information partially or completely disregards the comparison information. This behavior can be used to detect a critical driving state with an exceedance of permissible haptic feedback to a driver resulting from the respective comparison information and, for example, disregard it. Such a “critical difference” can, for example, be stored in the control unit, in particular at the factory. The same applies to so-called “critical driving state information”, which is detected, for example, as part of a comparison with a body electronics system. For example, when an electronic stability program detects a tendency of the motor vehicle to skid, haptic feedback to the driver is reduced in such a way that corrections to the driving state by the electronic stability program do not result in critical steering torques for the driver.

It has also been shown that, in particular, the feedback of a wheel steering angle and/or a difference between a target angle and an actual angle of the steering actuator and/or a corresponding return force provides particularly reliable information about the road-end driving state. In this context, the disclosure enables a particularly reliable prediction to be made on the basis of the corresponding signals and a corresponding latency time when processing the corresponding information according to the prior art to be avoided.

In a further aspect, the object is achieved by a vehicle, in particular a motor vehicle, having an electric steering device according to any one of the embodiments described above. Such a vehicle has a particularly comfortable and realistic steering with an electric steering device, so that a driver of the vehicle gets a particularly realistic impression of a road-end driving state, for example.

### BRIEF DESCRIPTION OF THE DRAWINGS

The disclosure is explained in more detail below using exemplary embodiments. In the drawings:

FIG. 1 shows a schematic representation of a steer-by-wire system for a motor vehicle,

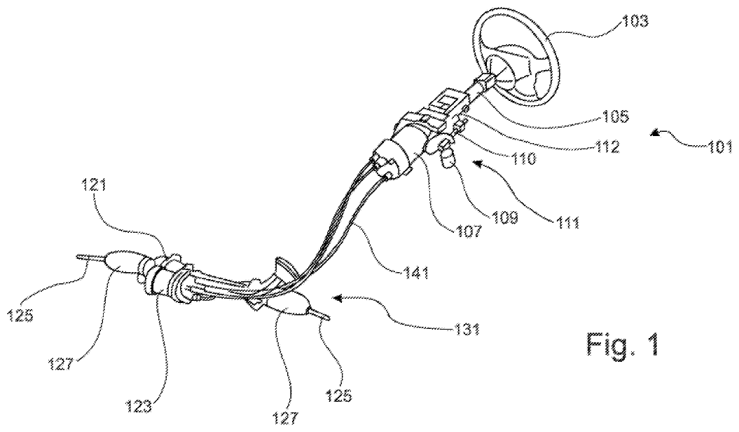

FIG. 2 shows a schematic circuit diagram of a hand torque control of the steer-by-wire system of FIG. 1, and

FIG. 3 shows a schematic circuit diagram of a road feedback transmitter from the circuit diagram of FIG. 2.

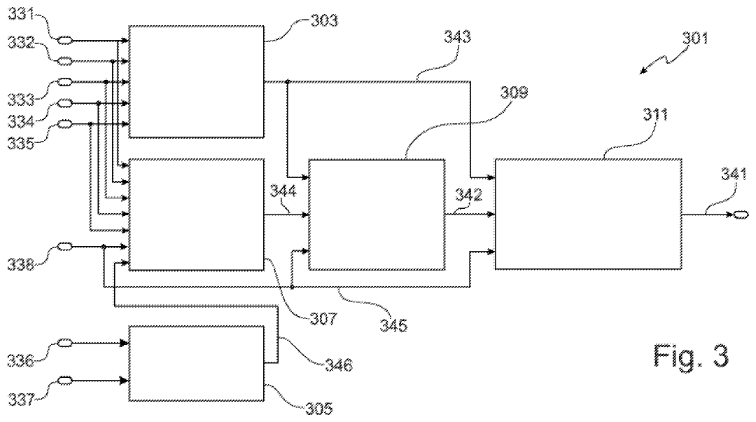

### DETAILED DESCRIPTION

A steering arrangement 101 is a so-called “steer-by-wire system”, i.e., an electric steering device with haptic feedback for a driver. The steering arrangement 101 has a steering wheel 103 which is rotatably mounted on a steering column 105. The steering column 105 extends into a so-called hand wheel actuator 111, which comprises a force feedback unit 107. This force feedback unit 107 has a rotation angle encoder (not shown), which provides information about a rotation angle of the steering column 105. This allows an input of a driver regarding the desired steering movement of the vehicle to be evaluated. Furthermore, an electric motor 109 is arranged on the force feedback unit 107 for generating haptic feedback on the steering wheel 103. The electric motor 109 is coupled to the steering column 105 via a motor shaft 110 and a gearing 112, so that the electric motor 109 can introduce a torque on the steering column 105 in order to generate the haptic feedback for the driver on the steering wheel 103.

The hand wheel actuator 111 is connected to a so-called road wheel actuator 131, i.e., the road-end steering arrangement, by means of a data connection 141 consisting of corresponding electrical cables. In this regard, the road wheel actuator 131 comprises a steering gear 121 with an electric motor 123, wherein the electric motor 123 linearly moves tie rods 125 of the steering gear so that, for example, wheels of a motor vehicle can be controlled with respect to a steering angle. For this purpose, the tie rods 125 are sealed with respect to the steering gear 121 using bellows 127 in order to prevent the ingress of dirt.

A hand torque control 201 can be part of a motor vehicle (not shown) and has the steering wheel 103, the steering column 105 and the motor 109 as mechanical components. The steering wheel 103 is mounted on the steering column 105 in a non-rotatable manner and arranged such that both have a common imaginary axis of rotation. Furthermore, the motor 109 is effectively connected to the steering column 105 by means of the motor shaft 110 and the gearing 112. The motor 109 can transmit torque to the steering wheel 103 in this way. Furthermore, a torque sensor 213 for acquiring the torque acting on the steering column 105 and an angle sensor 215 for acquiring the angular position of the steering column 105 and thus also the angular position of the steering wheel 103 are attached to the steering column 105. The unit consisting of the steering wheel 103, steering column 105, motor 109, motor shaft 110, gearing 111, the torque sensor 213 and the angle sensor 215 is thus suitable for receiving directional inputs from a driver issued by a turn of the steering wheel 103 and for outputting feedback in the form of an influenceable steering resistance using the motor 109 and its effective connection to the steering wheel 103 described above by means of a torque output by the motor 109.

A signal, namely the information on the steering angle position 251 from the angle sensor 215, is transmitted to a steering resistance transmitter 233 and to a steering wheel limit switch 229. A road feedback transmitter 235 receives a signal with the wheel feedback information 237 from a wheel control unit (not shown) and uses it to evaluate the necessary simulated return torques for the hand torque control 201. A corresponding signal is forwarded to a steering torque prioritizer 227. The signals from the steering resistance transmitter 233 and the road feedback transmitter 235 are evaluated in the steering torque prioritizer 227 and used to form information containing the necessary counter-torque on the steering wheel 103 derived from the rotation angle and road feedback. This information is forwarded to a target torque prioritizer 225.

Depending on the angular position of the steering wheel 103, the steering wheel limit switch 229 uses the information from the angle sensor 215 to acquire the angular position at which the steering wheel 103 reaches or would reach a virtual or real limit stop and also forwards this information to the target torque prioritizer 225. A wheel stop switch 231 receives signals for steering angle feedback 239 and for the target steering angle of the wheel control unit (not shown) and uses these to form a signal containing the information for reaching a maximum deflection of the wheel control unit and forwards this to the target torque prioritizer 225. The target torque prioritizer 225 determines a steering wheel target torque 249 from the signals of the steering torque prioritizer 227, the steering wheel limit switch 129 and the wheel stop switch 231, which is then forwarded to a motor torque control 223. In this regard, the target torque prioritizer 225 and the steering torque prioritizer 227 prioritize the sequence of incoming signal packets within a CAN bus environment in order to prevent overlaps and overwriting.

The motor torque control 223 is also supplied with a signal containing information on the steering wheel torque 243 and a motor specification torque 245 from a motor torque controller 221. The motor torque control 123 evaluates the motor specification torque 245 and the steering wheel torque 243 and uses this to determine a motor target torque 247, which is forwarded to the motor torque controller 221. This creates a closed control loop for controlling the motor target torque 247. The motor torque controller 221, the motor torque control 223, the target torque prioritizer 225, the steering torque prioritizer 227, the steering wheel limit switch 229 and the wheel stop switch 231 are implemented together as a microcontroller 253 and arranged in a common housing (not shown).

The output signal of the microcontroller 253 corresponds to the control signal for the motor 109. This signal is fed to a power control 219 and power electronics 217 for the motor 109 are controlled by this power control 219, which provides the necessary power for the motor 109. In this regard, only the energy required to operate the motor 207 is provided in the transmission path consisting of the microcontroller 253, the power control 219 and the power electronics 217. A possible falsification of the content of the signal from the microcontroller 253 is avoided as far as possible.

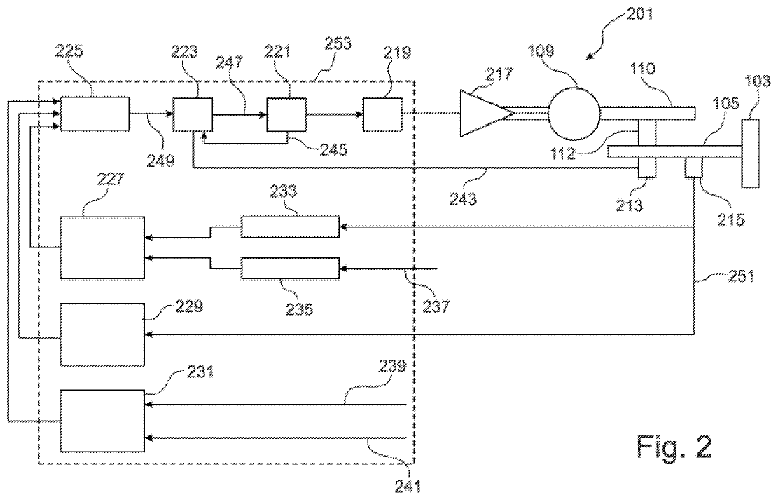

By means of the electrical power provided by the power electronics 217 and the motor 109, a steering torque calculated according to the input signals of the microcontroller 237, 239, 241 and 243 is then output to the steering wheel 103. This provides the driver with feedback on the current driving state (see FIG. 2).

A circuit diagram 301 shows the processes in the road feedback transmitter 235 in detail. First, a number of the shown circuit blocks will be explained.

An analytical steering torque model 303, a return force correction model 305, a neural network steering torque model 307 and a return force steering torque model 309 act together with a switch 311 so that a steering torque 341 can be output from the switch 311 as a result. In this regard, the analytical steering torque model 303 receives a vehicle speed 331, a steering wheel angle 332, a steering wheel angular velocity 333, a yaw velocity 334 and a yaw acceleration 335 as input variables. The yaw velocity 334 and the yaw acceleration 335 relate here to corresponding yaw data of the vehicle.

The same values are also fed to the neural network steering torque model 307, wherein this also receives an enabler signal 338 and a corrected return force 346 from the return force correction model 305. The return force correction model 305 receives feedback on a return force 336 of the steered wheels of a motor vehicle and a difference angle 337, which represents a difference between a target wheel steering angle and an actual wheel steering angle. The corrected return force 346 is calculated from these values in the return force correction model 305. As a result, the analytical steering torque model 303 outputs an analytical steering model 343, which is fed to the return force steering torque model 309. A return force estimated value from the neural network steering torque model is also fed to the return force steering torque model 309. The enabler signal 338 is likewise fed to the return force steering torque model 309. In this context, the analytical steering torque model 303 serves as a fall-back level and comprises a physical vehicle model into which the measurable input variables of the vehicle are input in order to be able to provide an estimate of the driving state as a result.

The switch 311 receives a NN steering torque 342 as a result of the return force steering torque model 309, as the steering model of the neural network. Furthermore, the analytical steering torque 343 and the enabler signal 338 are fed to the switch 311.

The neural network steering torque model 307 provides the return force estimated value 344 determined from a neural network, thus providing a prediction of a corresponding return force of the steered wheels without noticeable time delay. If the enabler signal 338 is activated, the neural network learns and improves its prediction. The enabler signal 338 can, for example, be switched to positive for a certain period of time prior to each journey or during a workshop visit to retrain the steering device. Within the return force steering torque model 309, the analytical steering torque 343 is then combined with the return force estimated value 344 and, if necessary, an additional enabler signal 338, so that the return force steering torque model can also be retrained or trained in an expanded capacity.

The reliability of the corresponding signal for generation is now checked within the switch 311. To this end, the NN steering torque 342 is compared with limit values stored in the switch 311, for example. If a corresponding limit value is exceeded, for example when a jump of a steering model is exceeded, the analytical steering torque 343 is switched to so that the steering torque calculated in the analytical steering model is taken into account and the NN steering torque 342 is disregarded.

As a result, a steering device is created which takes into account the return force of the steered wheels in a corresponding haptic feedback for the driver in the best possible way and without noticeable delay and is nevertheless secured by the fall-back level of the analytical steering torque 343 from the analytical steering torque model 303.

### LIST OF REFERENCE SYMBOLS

101 Steering arrangement
103 Steering wheel
105 Steering column
107 Force feedback unit
109 Electric motor
110 Motor shaft
111 Hand wheel actuator
121 Steering gear
123 Steering motor
125 Tie rod
127 Bellows
131 Road wheel actuator
141 Data connection
201 Hand torque control
210 Motor shaft
212 Gearing
213 Torque sensor
215 Angle sensor
217 Power electronics
219 Power control
221 Motor torque controller
223 Motor torque control
225 Target torque prioritizer
227 Steering torque prioritizer
229 Steering wheel limit switch
231 Wheel stop sensor
233 Steering resistance transmitter
235 Road feedback transmitter
237 Wheel feedback
239 Steering angle feedback
241 Target steering angle
243 Steering wheel torque
245 Motor specification torque
247 Motor target torque
249 Steering wheel target torque
251 Steering angle position
253 Microcontroller
301 Circuit diagram
303 Analytical steering torque model
305 Return force correction model
307 Neural network steering torque model
309 Return force steering torque model
311 Switch
331 Vehicle speed
332 Steering wheel angle
333 Steering wheel angular velocity
334 Yaw velocity
335 Yaw acceleration
336 Return force
337 Difference angle
338 Enabler signal
341 Steering torque
342 NN steering torque
343 Analytical steering torque
344 Return force estimated value
345 Enable signal
346 Corrected return force

1. An electric steering device for controlling a vehicle, comprising:
a rotation angle encoder,
a steering wheel corresponding with the rotation angle encoder,
an electric motor, mechanically connected to the steering wheel, the electric motor configured for outputting a torque onto the steering wheel,
a steering actuator configured to steer a wheel of the vehicle, and
a control unit, and
a steering movement of the steering actuator is controlled via the control unit when a rotational input is applied to the steering wheel via the rotation angle encoder, and
haptic feedback relating to a driving state is introduced into the steering wheel via the electric motor using a transmission function stored in the control unit and using aggregated information about a road-end steering state at the steering actuator, and
the aggregated information for determining the road-end steering state comprises first comparison information, determined in a prediction device, depending on driving state information about the vehicle.

2. The electric steering device according to claim 1, wherein the aggregated information for determining the road-end steering state further comprises second comparison information, third comparison information and/or further comparison information determined in the prediction device.

3. The electric steering device according to claim 1, wherein the prediction device comprises an artificial neural network configured to predict a future road-end steering state, wherein the artificial neural network is limited via limit values for limiting a permissible range of values of the first comparison information.

4. The electric steering device according to claim 3, wherein the artificial neural network is repeatedly trained via the driving state information of the vehicle.

5. The electric steering device according to claim 4, wherein the aggregated information comprises reference information about a road-end driving state.

6. The electric steering device according to claim 5, wherein the reference information is a result of an analytical basic function of a vehicle model of the vehicle depending on the driving state information.

7. The electric steering device according to claim 6, wherein the first comparison information includes an applied adjustment factor and/or a filter.

8. The electric steering device according to claim 7, wherein the electric steering device is configured such that when it is detected that a critical difference between the reference information and the first comparison information is exceeded and/or a critical driving state information is detected by means of a comparison with a non-critical driving state information, the aggregated information partially or completely disregards the first comparison information.

9. The electric steering device according to claim 2, wherein the driving state information of the vehicle comprises information about:
a return force of the steering actuator, and/or
an angle of the steering actuator, and/or
a difference between a target angle of the steering actuator and an actual angle of the steering actuator, and/or
a difference between a target wheel steering angle and an actual wheel steering angle.

10. A motor vehicle, comprising an electric steering device according to claim 2.

11. The electric steering device according to claim 1, wherein the first comparison information is related to a driving behavior of a first driver.

12. The electric steering device according to claim 2, wherein the second comparison information is related to a driving behavior of a second driver, the third comparison information is related to a driving behavior of a third driver, and the further comparison information is related to different driving behaviors of further drivers.

13. An electric steering device for controlling a vehicle, comprising:
a rotational input,
a rotation angle encoder configured to evaluate the rotational input,
a steering actuator mechanically disconnected from the rotational input and configured to move steerable wheels of the vehicle,
a control unit,
a force feedback unit configured to:
provide haptic feedback using a transmission function stored in the control unit, and
use aggregated information about a road-end steering state at the steering actuator, and
the aggregated information for determining the road-end steering state comprises first comparison information, determined in a prediction device, depending on driving state information about the vehicle.

14. The electric steering device according to claim 13, wherein the first comparison information is related to a driving behavior of a first driver.

15. The electric steering device according to claim 14, wherein the aggregated information for determining the road-end steering state further comprises second comparison information and third comparison information.

16. The electric steering device according to claim 15, wherein the second comparison information is related to a driving behavior of a second driver, and the second comparison information is related to a driving behavior of a third driver.

17. The electric steering device according to claim 13, wherein the prediction device comprises an artificial neural network configured to predict a future road-end steering state.

18. The electric steering device according to claim 17, wherein the artificial neural network is limited via limit values for limiting a permissible range of values of the first comparison information.

19. The electric steering device according to claim 17, wherein the artificial neural network is repeatedly trained via the driving state information.

20. The electric steering device according to claim 13, wherein the aggregated information comprises reference information about the road-end driving state.
